(19) United States
(12) Patent Application Publication
(10) Pub. No.: US 2015/0039435 A1
(43) Pub. Date: Feb. 5, 2015

(54) DayMal.com

(71) Applicant: MOSTAFA SHAHEE, Kingston (CA)

(72) Inventor: MOSTAFA SHAHEE, Kingston (CA)

(21) Appl. No.: 13/956,286

(22) Filed: Jul. 31, 2013

(51) Int. Cl. G06Q 30/02

(52) U.S. Cl. CPC G06Q 30/0259
USPC 705/14.57

(57) ABSTRACT

The present invention is an internet technology-based system (e.g., webpage) which facilitates discount sales and shoppings. The system categorizes the discount sales as both online and offline sales. The online and offline sellers are provided some facilities to open and design the interior features of their own shops through this system and target their potential customers. In addition, the offline sellers (by using IP geoilocation) are allowed to restrict their target markets in order to advertise their goods and services to potential customers in a particular country, state, city or distinct in a more effective way.

### FIELD OF INVENTION

The present invention relates to a system, software and method for a computerized procurement, sales and advertisement using a computer network, and more particularly to a system, software and method using the internet to establish multi-item procurement, sale and advertisement of goods and services.

### BACKGROUND OF THE INVENTION

For any product that can be described and priced per item, per weight or by how it is packed, online procurement has been an efficient way of selling and purchasing the item. This applies to variety of items from various sources including the wholesalers and retailers who actively take advantage of internet technology to connect to their potential customers. In addition offering some options such as “auction” or “free shipping” to the buyers mostly encourages them to purchase an item with a competitive price.

However, there are a number of drawbacks to these online sellers which do not bring purchasers the best items available at any given time. While these online sellers serve well in their role, the existence of a number of such websites, which almost provide the same services, acts as an obstacle for buyers to shop their desired item in a competitive price since it is very time consuming to search for an item with the least price specially during the periods that all the items of a specific seller are subject to a discount.

Nevertheless providing a specific website for on sale items which brings variety of discounted items from different sellers in the same place will benefit both sellers and purchasers in a way that sellers can target their customers more effectively and buyers can shop their desired items for the least price.

Another drawback with those websites is that they do not procure some facilities for interior design of their ad profiles such that they are only given a specific feature and space to describe their products and launch their ad profile and all the sellers obliged to follow the same standard for the feature and design of their ad profiles where this obligation may restrict the marketing ability of sellers.

The present invention provides some tools and facilities and specific space for the sellers to choose different color and background to design and decorate their own online shops and ad profile depending on the category of products to influence the buyers more effectively.

Another restriction of those websites is that price of items are limited to a few major unit of currency and this imposes considerable transaction costs to buyers who have to convert their local currency to the specified unit currency of on sale items.

The present invention allows sellers to choose a variety of unit currencies for pricing their items depending on the country where their online shops are originated from. Likewise it will offer the same unit of currency for pricing of items to buyers from same region or country to allow them to save more money.

Another important feature of this invention is that it allows all retailers or wholesalers, who are not involved with online sale but wish to introduce their goods and services to their local potential customers through internet technology, to advertise their goods and services very effectively. Every day we can observe that a tremendous amount of money is spent on paper advertisement by small businesses to inform their local customers about the discount or clearance sales, new goods and services and so on. But this approach of advertisement seems not to be very effective since despite the fact that it imposes too much costs to business owners, it does not target the potential customers very effectively. The present invention provides a facility for business owners to create their online shops and ad profile and restrict their ad profile to a country, province or state, city or a distinct when necessary. This process can be done using IP geolocation or any other relevant technologies to map the IP address of customers. On the other side, it allows customers to sign in to the websites and limit their search to the geographic places where they reside or desire and see all the businesses who have clearance sale or any special offer. In this case, the business owners will be charged on per click basis in addition to a fixed launch fee.

To fulfill these aims in highest extend, these facilities are offered to sellers and purchasers through a variety of different languages to ease access to the system and take advantage of it more effectively.

### OBJECTS AND SUMMARY OF THE INVENTION

It is an object of the present invention to provide a network-based system to facilitate any discount sale and purchase of goods and services for business owners as well as customers.

It is an object of the present invention to provide some facilities and tools to allow vendors to design their online shops and ad profile features as they desire.

It is another object of the present invention which enables vendors and buyers to choose a local currency unit for item price to save transaction cost for local customers.

It is another object of the present invention to allow the vendors to create their business directory and ad profile with variety of languages, and also allows the buyers to see those adds in any language that they desire.

It is another object of the present invention to provide offline sale and purchase options. This is mainly designed for local advertisement purposes which allow vendors to target their potential customers effectively and also allows buyers to seek for any special offer made by local or domestic business owners including clearance sale, discount sale and so on.

It is another object of the present invention to allow vendors to restrict their ad profile within a geographical district, city, province or state and a country.

### BRIEF DESCRIPTION OF THE DRAWINGS

The present figures illustrate one or more applications of present invention in which together with the detailed description, explains the principles and all aspects of the invention.

FIG. 1 is a generalized process flowchart of access of a typical vendor to sign up and create an ad profile under offline sale option which is provided by the present invention.

FIG. 2 is a generalized process flowchart of access of a typical purchaser to see ad board under offline purchase option which is provided by the present invention whether as a registered or guest customer.

FIG. 3 is a generalized process flowchart of access of a typical vendor to sign up and create ad profile under online purchase option which is provided by the present invention.

FIG. 4 is a generalized process flowchart of access of a typical purchaser to search under online purchase option which is provided by the present invention whether as a registered or guest customer.

FIG. 5 shows the homepage used by users to connect to the present invention.

FIG. 6 is designed for users to get access to the system.

FIG. 7 is designed for the user to sign up to the system as a registered member.

FIG. 8 is designed for sellers to choose their payment method.

FIG. 9 is designed for sellers who wish to contribute in offline sale in which it allows users to create and save their business profile.

FIG. 10 is designed for sellers who wish to contribute in offline sale in which it allows users to design, create, save and launch their ad profile.

FIG. 11 is designed for sellers who wish to contribute in online sale option in which it allows users to design, create, save and launch their ad profile.

FIG. 12 is designed for purchasers who wish to contribute in offline shopping in which it allows users to search their ad directory and see the desired ad board.

FIG. 13 shows a typical ad board presenting to purchasers as they search and limit their ad directory to a specified district, city, province or country.

FIG. 14 shows a typical ad board designed by a specific seller which is presented to purchasers who wish to take advantage of offline shopping.

FIG. 15 shows a typical online ad board search for the purchasers who wish to shop online.

### DETAILED DESCRIPTION

The applications of present invention are herein, described in the context of an online system to mainly facilitate discount sale and purchase, categorized as offline and online sales/purchases. It should be noted that the detailed description of the present description is illustrative and is not intended to be limiting. The embodiments of the present invention will result that sellers and buyers take advantage of this invention.

To implement this invention, various types of operating systems, computer programs and related machines to link the components, process steps and data structures are used. In addition, devices such as hardwired devices, field programmable gate arrays (FPGA), application specific integrated circuits (ASIC), IP geoilocation and etc. maybe used without departing from scope of novelty of present invention.

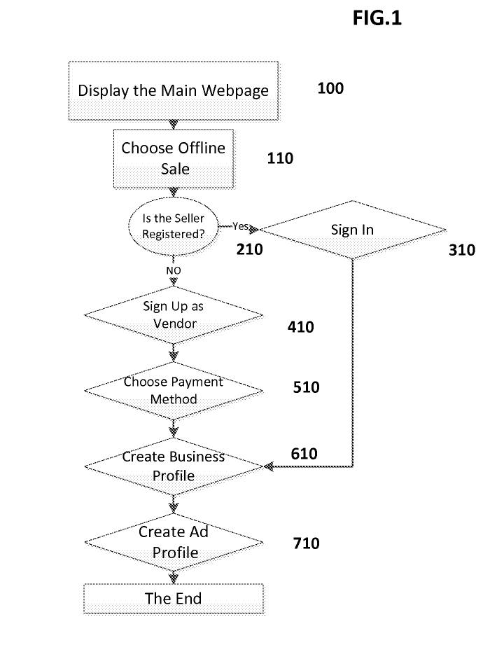

A generalized flowchart used to access to the present invention is shown if FIG. 1 to FIG. 4 depending on whether a user is classified as vendor or purchaser and also whether he/she intends to be involved with online or offline sale/purchase.

FIG. 1 present a complete cycle of which a seller may choose to participate in offline sale option. Starting point is 100 where a user connects to the system through internet and observes all four provided options on the screen. In the second step 110, user chooses “offline sale” option. In the next step 210, the identification process takes place. In case the user has not sign up before, he/she will be directed to next steps, 410 and 510, to sign up and select a payment method in order to take advantage of the present invention. If user has signed up before he/she will be directed to the next step, 310, where the user is able to sign in, via a unique username and password provided by the system. Successful identification process leads to the next step, 610. In this step, the user is obliged to create his/her business profile followed by creating his/her ad profile, 710 and the cycle will be ended at this point.

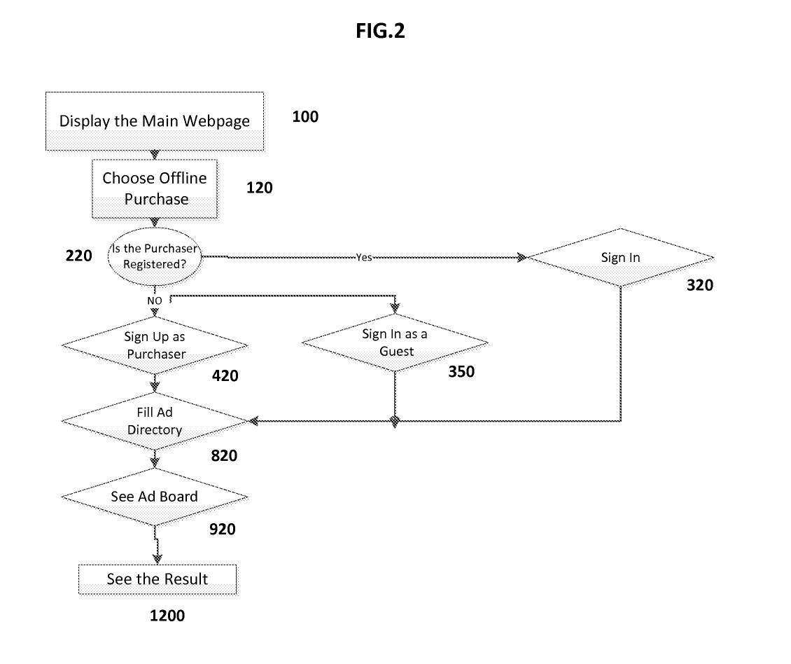

FIG. 2 present a complete cycle of which a purchaser gets involved with “offline purchase” option. Starting point is 100 where a user connects to the system through internet and observes all four provided options on the screen. In the second step 120, user chooses “offline purchase” option. In the next step 220, the identification process takes place. In case the user has not signed up before, he/she will be given two choices to access to the system. He may sign up to the system, 420, or access to the system as a guest, 350. If the user has signed up before, he/she will be directed to the next step, 320, where he/she simply signs in via a unique username and password provided by the system. Successful identification process leads to the next step, 820. In this step the user is obliged to fill an ad directory in order to be able to see the ad boards as a final step, 920, and the cycle will be ended at this point.

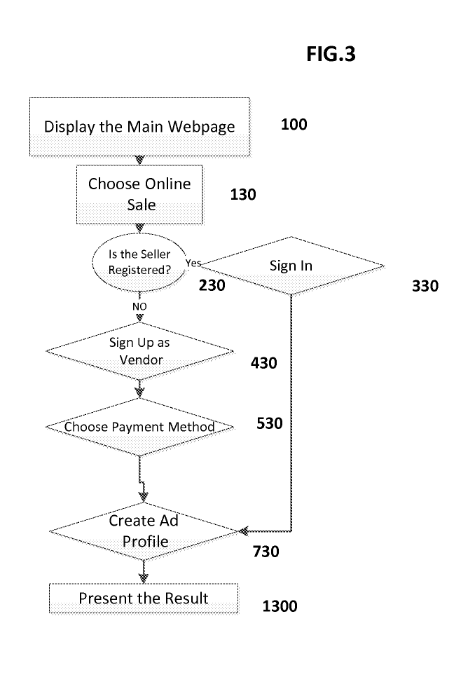

FIG. 3 present a complete cycle of which a seller may choose to participate in online sale option. Starting point is 100 where a user connects to the system through internet and observes all four provided options on the screen. In the second step 130, the user chooses “online sale” option. In the next step 230, the identification process takes place. In case the user has not signed up before, he/she will be directed to next steps, 430 and 530, to sign up and select a payment method in order to take advantage of the present invention. If the user has signed up before he/she will be directed to the next step 330, where the user simply signs in via a unique username and password provided by the system. Successful identification process leads to the next step where the user is obliged to create his/her ad profile, 730 and the cycle will be ended at this point.

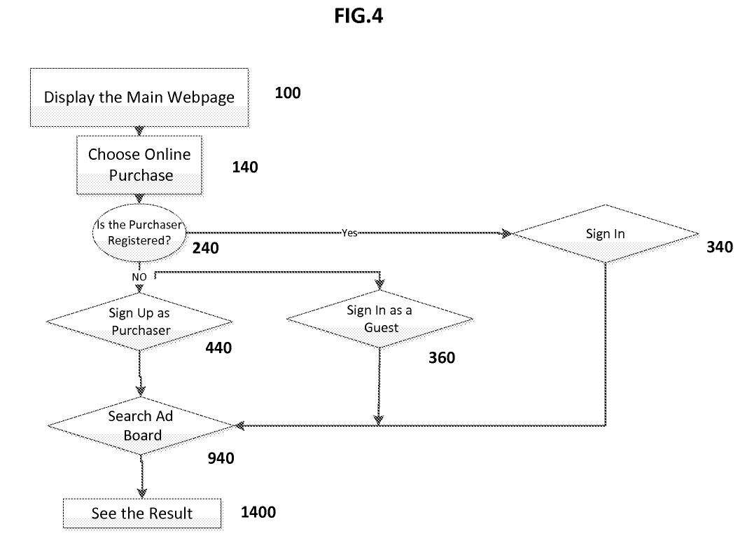

FIG. 4 present a complete cycle of which a purchaser gets involved with “online purchase” option. Starting point is 100 where a user connects to the system through internet and observes all four provided options on the screen. In the second step 140, user chooses “online purchase” option. In the next step 240, the identification process takes place. In case the user has not signed up before, he/she will be given two choices to access to the system. He may sign up to the system, 440, or access to the system as a guest user, 360. If the user has signed up before, he/she will be directed to the next step, 340, where he/she simply signs in via a unique username and password provided by the system. Successful identification process leads to the next step, 940. In this step the user is able to search for an ad board in order to make his/her online shopping, and the cycle will be ended at this point.

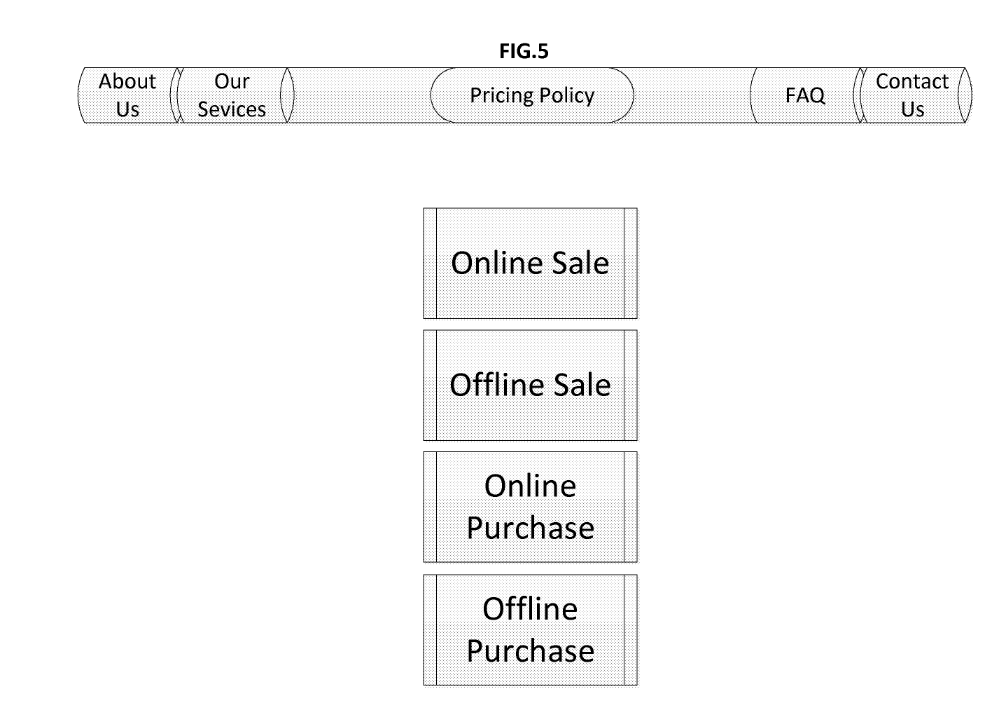

FIG. 5 shows a typical homepage for a website titled as DayMal.com. This page as a starting point for the users, in order to take advantage of the present invention, hosted a head bar which provides basic but necessary information for the users including a brief summary about the aim of the website, our services, pricing policy, frequently asked question as well as contact information. On the main body of the page, there are four icons designed for the users to specify whether they plan to access to the system through online sale, online purchase, offline sale or offline purchase. This identification process takes place by clicking on any of four provided icons.

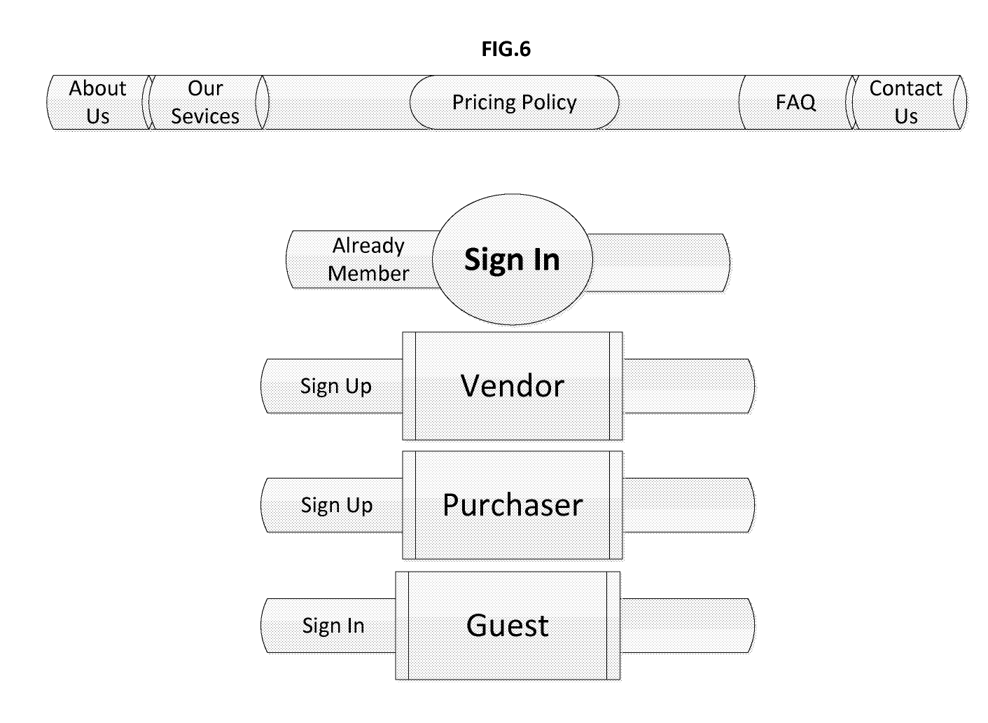

As soon as the type of users are identified, they will be directed to FIG. 6 where they are required to sign up to get access to the system. In addition it directs users to the system in case they are already registered in the system or they wish to take advantage of the system as a Guest User (which is only designed only for purchasers).

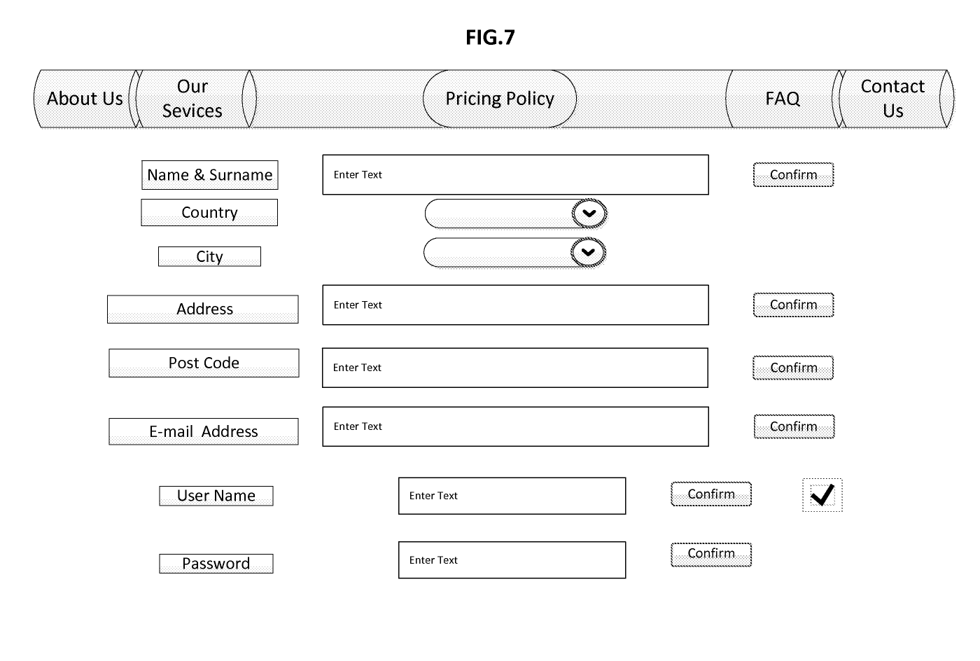

FIG. 7 shows a typical registration page provided for those users who desire to be registered users of the system including buyers and sellers no matter they wish to take the advantage of online or offline sale or purchase. In this regard, they are obliged to provide their name, country and city where they reside, postal code as well as a valid email address. They also need to create a valid username and password for easy future referral.

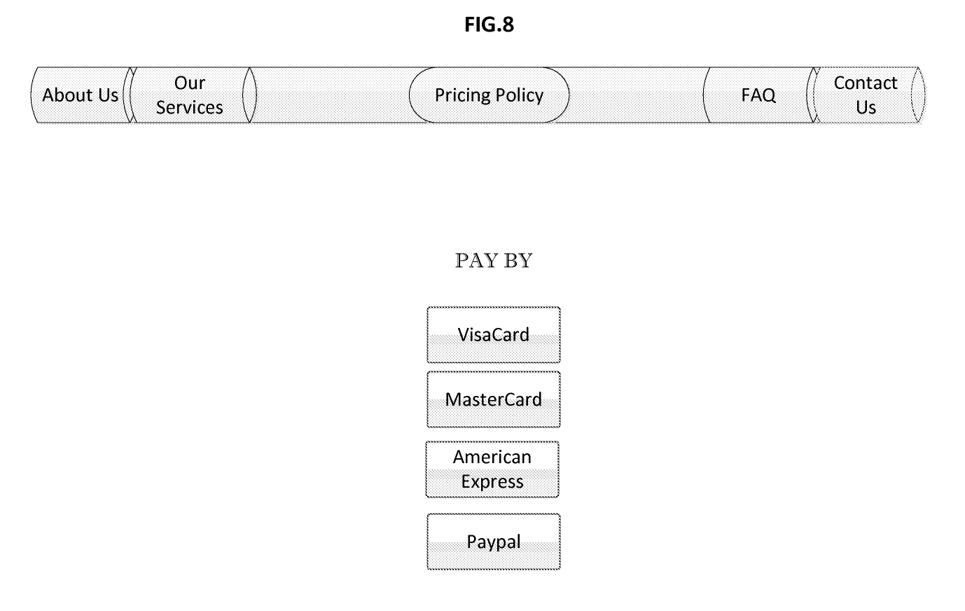

FIG. 8 has been designed for users who desire to take advantages of the system as sellers including online sale and offline sale. The users are obliged to verify the method of payments to be able to use the system to advertise or sale their products.

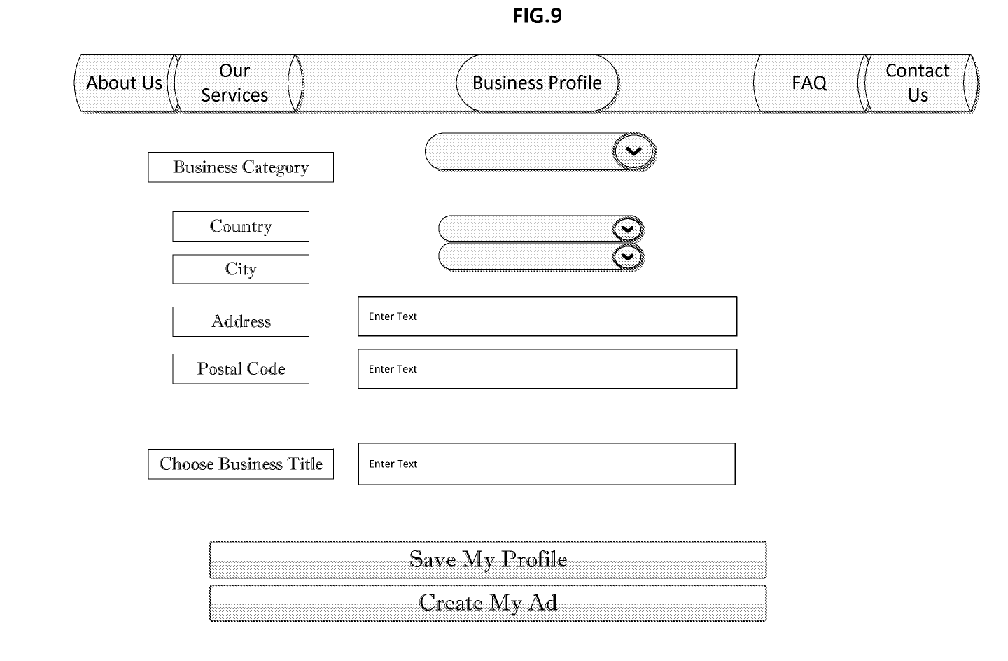

FIG. 9 is designed for users who desire to take advantages of the system as offline vendors or sellers. This figure, named as business profile, requires them to choose their business category, country, city, address, and postal code of where their business is located. After choosing their business title, they can save their business profile and start the process of creating their Ad Profile by clicking on the related icon.

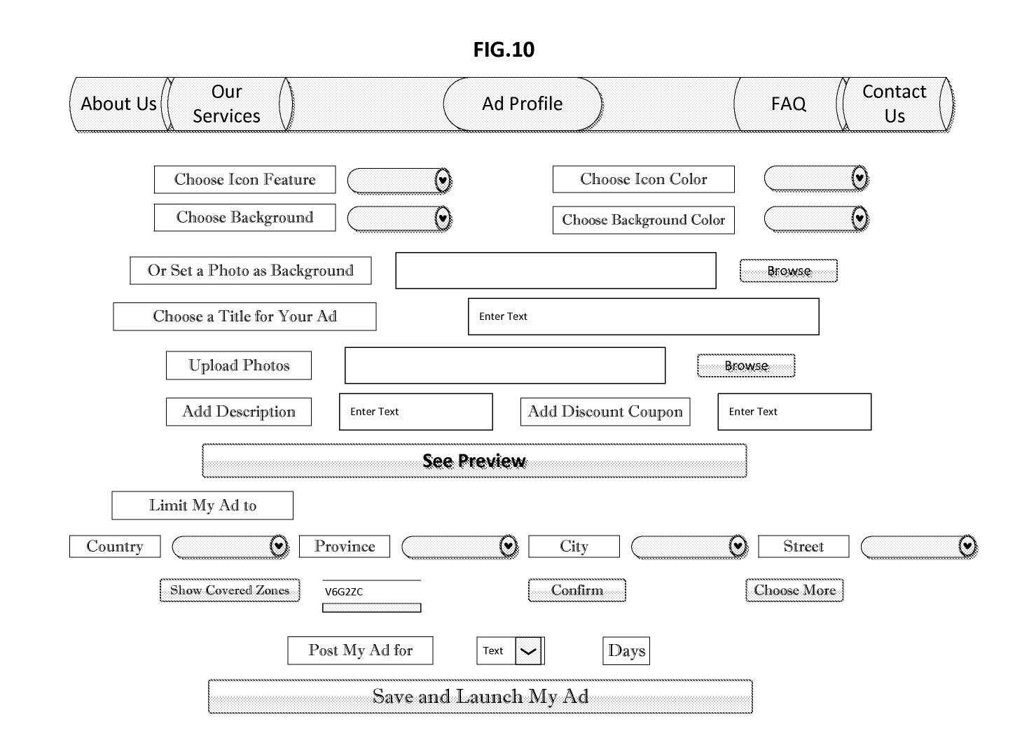

FIG. 10 is designed as a complement step for [00044] where sellers are able to create their own Ad Profile which basically they are allowed to choose or design varieties of icon features and colors as well as different format of backgrounds, or set a photo as background of their ad profile for interior design purposes, in addition to uploading photos of their products. Furthermore at this stage, they may restrict their ad profile to a specific country, province or state, city or a district and launch it for a specific time period if they desire to do so.

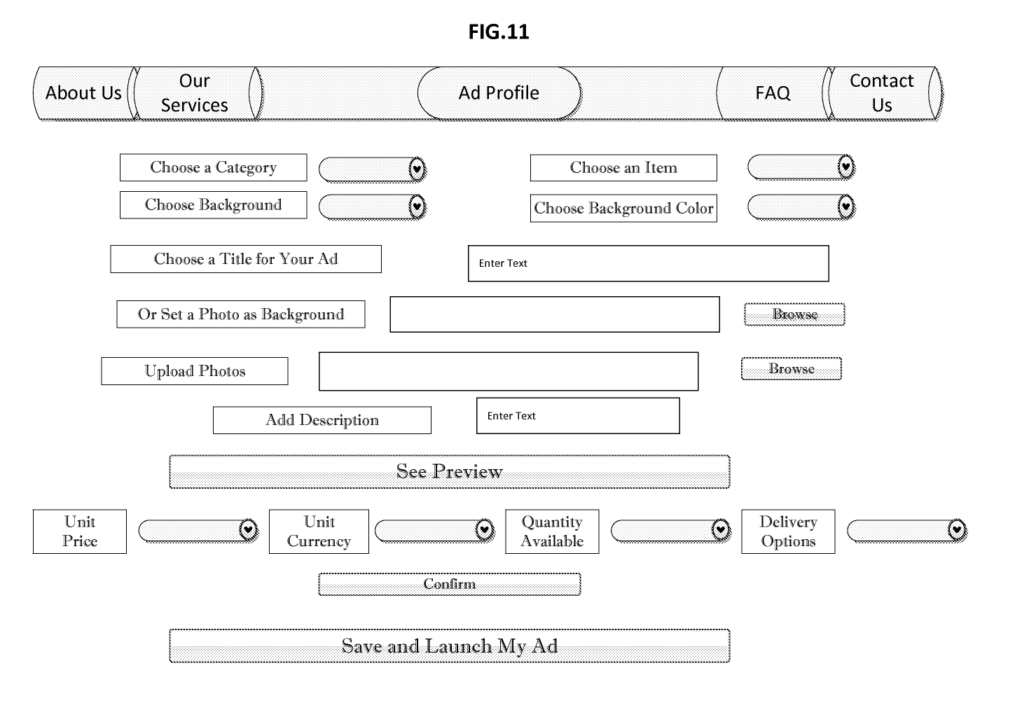

FIG. 11 is designed for the users who wish to take advantage of the system as online sellers in which they are able to create their own Ad Profile which basically requires them to choose category of their business, item type, background and background color or set a photo as background of their ad profile, in addition to uploading photos of their products. Furthermore at this stage, they are obliged to choose the unit price and currency, quantity available and delivery options before launching their ad profile.

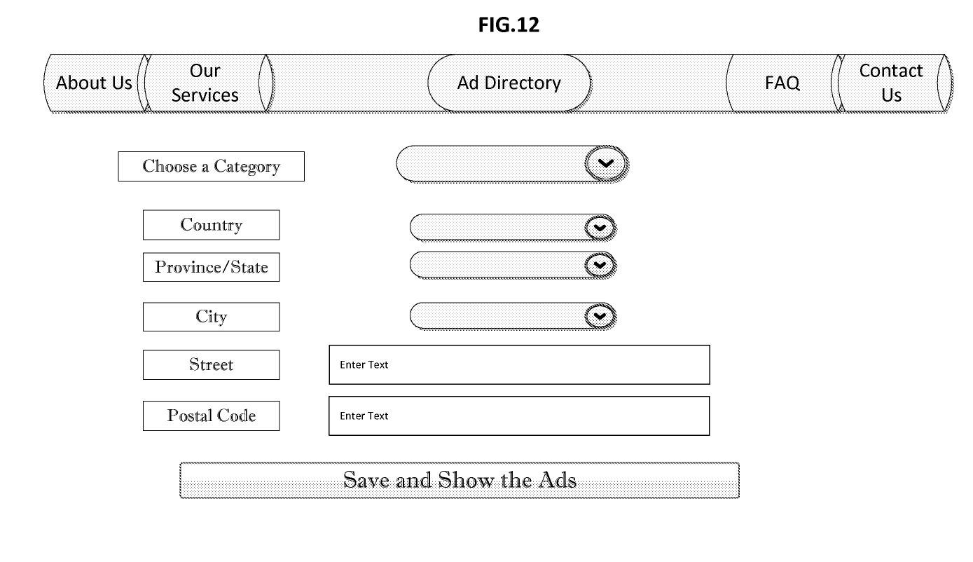

FIG. 12 shows a typical “Ad Directory” which is designed for users who desire to take advantage of the system as offline purchasers. In this case, they are required to choose the category of businesses in which they wish to do shopping from, their residential addresses including country, province or state, city, street and postal code.

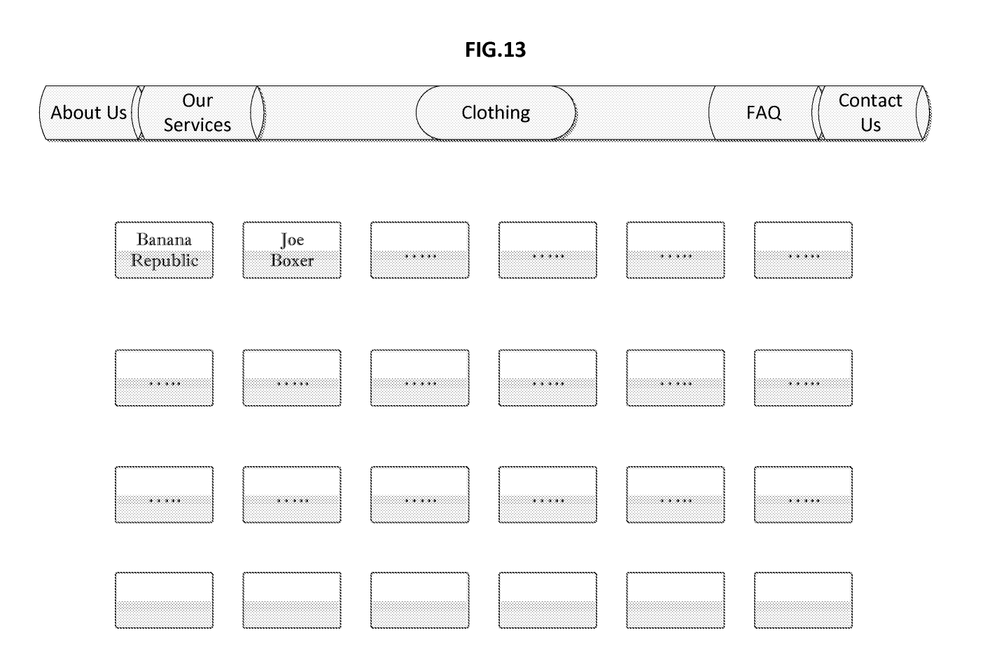

FIG. 13, as a complement step for [00046], shows a typical ad board presented to users who to search for offline purchase around where they reside or look for. As it is shown, on this ad board, a list of all shops around a chosen district or city or . . . are presented such that clicking on any of those icons will direct buyers to the virtual shops to be informed about the special offers or discount sale of those shops.

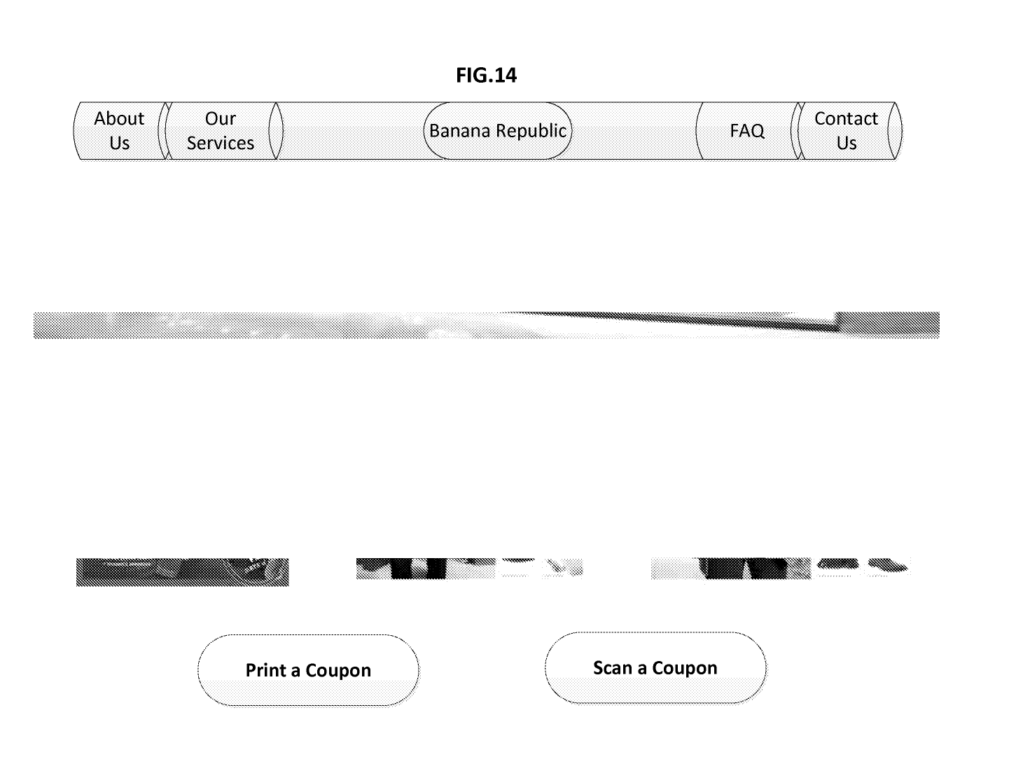

FIG. 14, as a complement step for [00046] and [00048], shows a typical ad profile designed by a specific seller presented to users who to search for offline purchase around where they reside or look for. As it is shown, on this ad profile, list of all items on sale are presented such that a purchaser is able to print or scan a related discount coupon.

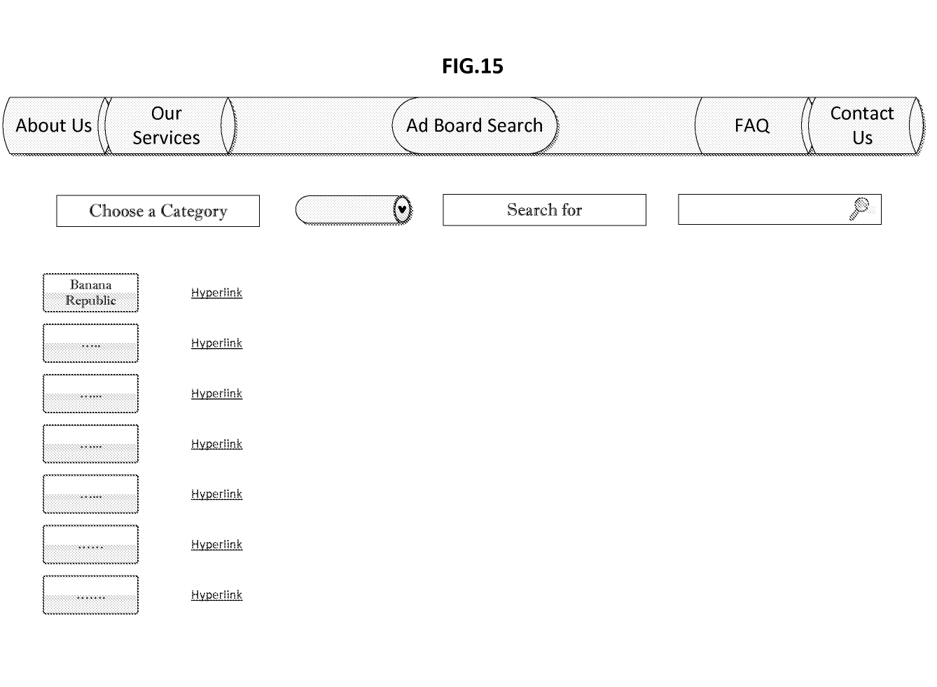

FIG. 15 shows a typical ad board search page presented to users who try online purchase. As it is shown on this ad board search users are required to choose the category and type of item. When the search process is implemented, the result will be presented to them as a list of hyperlink of all individual sellers who sell the same product. Clicking on each hyperlink will direct users to the related page to complete their shopping.

1. A method of online and offline sale and purchases of goods and services compromising with
a. A system designed to allow vendors to open their online shops in order to take advantage of offline sale (by introducing their on sale commodities) as well as online sale via a network;
b. A system to allow sellers (online and offline sellers) to follow their own taste and style to design and create their online shops to introduce commodities more effectively. This includes icon types, background features colors and any other features which compromise with their tastes in designing their online shops, where a mechanism will save these features;
c. A system which allows sellers who do not participate in online sale but wish to advertise their commodities and services online, especially during the period when they have any special offer or clearance sale. In this regards, after opening an online shop, a mechanism allows them to restrict their advertisements to a particular country, province or state, city district or region. Likewise it allows buyers to restrict their search to a particular country, province or state, city, distinct or region to take advantage of offline shopping.

2. A method of claim 1(b): wherein business owners are able to create their own ad profile, after creating their business profile, to be identified where as these ad profiles are sorted under related business types by an automated system.

3. A method of claim 1(b): wherein business owners are provided some options to choose an icon feature and icon color to distinct their ad profile from the others. In addition they are provided some options to choose the background feature and background color of their ad profile or to upload some photos instead in better designing their ad profiles.

4. A method of claim 1(c): wherein business owners are able to add a discount coupon for customers for future print or scanning.

5. A method of claim 1(c): wherein business owners are able to restrict their ad profile to a particular country, state or province, city, district or a street and also to restrict the duration of their ad for a specific time period.

6. A method of claim 1(c): wherein purchasers (who wish to follow offline shopping) are able to create their ad directory and even restrict it to a particular country, state or province, city, district or a street to follow online ads around their residential address and save it for future referral.

7. A method of claim 1(c): wherein purchasers are able to see a list of all businesses, followed by creating their ad directory, in which a click on related icon will lead them to related ad profiles.

8. A method of claim 1(c): wherein purchasers are able to see a list of all businesses, followed by creating their ad directory, in which a click on related icon will lead them to related ad profiles.

9. A method of claim 1(c): wherein purchasers are able to see ad profiles related to each particular business and print or scan a related coupon.

10. A method of claim 1(d): wherein business owners (who wish to participate in online sale) are able to choose currency unit and fill delivery options to present to purchasers.

11. A method of claim 1(a): wherein purchasers (who wish to participate in online shopping) to implement their searches by filling ad board search and choosing a desired category. The system will present the results as hyperlink in which a click on this hyperlink will lead them to complete their online shopping.
